(19) United States
(12) Patent Application Publication
(10) Pub. No.: US 2025/0213422 A1
(43) Pub. Date: Jul. 3, 2025

(54) MASSAGE DEVICE AND MASSAGE METHOD

(71) Applicant: Dongguan Mimao Electronic Technology Co., Ltd., Dongguan (CN)

(72) Inventor: Qinling Wang, Heyuan (CN)

(21) Appl. No.: 19/084,705

(22) Filed: Mar. 19, 2025

Related U.S. Application Data
(63) Continuation-in-part of application No. 18/940,778, filed on Nov. 7, 2024.
Application No. 18/940,778 is a continuation-in-part of application No. 18/746,012, filed on Jun. 17, 2024.
Application No. 18/746,012 is a continuation-in-part of application No. 18/516,984, filed on Nov. 22, 2023, now Pat. No. 12,161,598.

(30) Foreign Application Priority Data
Jan. 23, 2025 (CN) 202510111846.0

(51) Int. Cl. A61H 19/00

(52) U.S. Cl. CPC A61H 19/32; A61H 2201/0153; A61H 2201/0157; A61H 2201/1669; A61H 2201/1678

(57) ABSTRACT

A massage device includes a swinging unit, a first stimulation unit and a second stimulation unit. The swinging unit includes a plurality of swinging bars, and a chamber for accommodating a male penis is defined among the swinging bars. The first stimulation unit is connected to the swinging bars, configured for driving the swinging bars to move towards or away from a central axis of the chamber. The second stimulation unit is connected to the first stimulation unit, configured for driving the first stimulation unit and the swinging unit to move along an axial direction of the chamber.

### CROSS-REFERENCE TO RELATED APPLICATIONS

This application is a continuation in part application of application Ser. No. 18/940,778 filed on Nov. 7, 2024, which is a continuation in part application of application Ser. No. 18/746,012 filed on Jun. 17, 2024, which is a continuation in part application of application Ser. No. 18/516,984, filed on Nov. 22, 2023, and claims priority of Chinese Patent Application No. 202510111846.0, filed on Jan. 23, 2025, the entire contents of which are hereby incorporated by reference.

### TECHNICAL FIELD

The present application relates to the technical field of adult products, and in particular to a massage device and a massage method.

### BACKGROUND

In recent years, various adult products have been developed to help users enhance their sexual experience. Generally, an existing massage device uses vibration motor(s) to provide high-frequency vibration to stimulate the user's body, particularly stimulate the sensitive areas of the body, such as the breast, the penis and the like, which has poor stimulation effect and thus is difficult to meet users' needs.

### SUMMARY

An object of the present application is to provide a massage device and a massage method based on the massage device, providing better stimulation effect.

On one aspect, an embodiment of the present application provides a massage device, including:
a swinging unit including a plurality of swinging bars, a chamber for accommodating a male penis being defined among the swinging bars;
a first stimulation unit being connected to the swinging bars, configured for driving the swinging bars to move towards or away from a central axis of the chamber; and
a second stimulation unit connected to the first stimulation unit, configured for driving the first stimulation unit and the swinging unit to move along an axial direction of the chamber.

On another aspect, an embodiment of the present application provides a massage method based on the above massage device, including:
S1, enabling the swinging unit of the massage device at a first position and in an open state;
S2, driving the swinging unit to move along the axial direction of the chamber from the first position to a second position;
S3, enabling the swinging unit at the second position in a clamping state; and
S4, driving the swinging unit to move along the axial direction of the chamber from the second position to the first position.

Compared with the prior art, the massage device and massage method according to embodiments of this application clamps the male penis through the radial movement of the swinging bars, and at the same time pulls the male penis through the axial movement of the of the swinging bars, resulting in a better stimulation effect and a more comfortable user experience.

### BRIEF DESCRIPTION OF THE DRAWINGS

In order to illustrate the technical solution in embodiments of the present application more clearly, the following briefly introduces accompanying drawings used in the description of the embodiments. Obviously, the accompanying drawings in the following description are only some embodiments of the present application. Those of ordinary skill in the art can obtain other accompanying drawings from these accompanying drawings without any creative efforts.

FIG. 1 is an isometric, assembled view of a massage device according to a first embodiment of the present application.

FIG. 2 is a top plan view of the massage device of FIG. 1.

FIG. 3 is a cross sectional view of the massage device taken along line III-III of FIG. 2.

FIG. 4 is an exploded view of the massage device of FIG. 1.

FIG. 5 is a further exploded view of a second stimulation module of the massage device of FIG. 1.

FIG. 6 is an exploded view of the second stimulation module of FIG. 5 viewed from another aspect.

FIG. 7 is a further exploded view of a gearbox of the second stimulation module of FIG. 5.

FIG. 8 is a schematic view of a second stimulation module of a massage device according to a second embodiment of the present application.

FIG. 9 is an isometric, assembled view of a massage device according to a third embodiment of the present application.

FIG. 10 is a cross-sectional view of the massage device of FIG. 9.

FIG. 11 is a schematic view of the massage device of FIG. 9, wherein an outer shell and a half of an inner shell are removed to show stimulation modules inside the shell.

FIG. 12 is an exploded view of FIG. 11.

FIG. 13 is an isometric, assembled view of a massage device according to a fourth embodiment of the present application.

FIG. 14 is a top view of the massage device of FIG. 13.

FIG. 15 is a cross-sectional view taken along line XV-XV of FIG. 14.

FIG. 16 is an exploded view of the massage device of FIG. 13.

FIG. 17 is a further exploded view of a first stimulation unit of the massage device of FIG. 16.

FIG. 18 shows a further exploded view of the first stimulation unit, wherein a mounting seat of the first stimulation unit is removed.

FIG. 19 is a further exploded view of a second stimulation unit of the massage device of FIG. 16.

FIG. 20 is an exploded view of the second stimulation unit viewed from another aspect.

FIG. 21 is a schematic view of the massage device of FIG. 13 in a second state.

FIG. 22 is a cross sectional view of the massage device of FIG. 21.

FIG. 23 is a schematic view of the massage device of FIG. 13 in a third state.

FIG. 24 is a cross sectional view of the massage device of FIG. 23.

FIG. 25 is a schematic view of the massage device of FIG. 13 in a fourth state.

FIG. 26 is a cross sectional view of the massage device of FIG. 25.

FIG. 27 is a flowchart of a massage method according to an embodiment of the present application.

### DESCRIPTION OF THE EMBODIMENTS

In order to make those skilled in the art better understand the technical solution of the present application, the technical solution in the embodiments of the present application will be clearly and completely described below with reference to accompanying drawings in the embodiments of the present application. Obviously, the described embodiments are only a part of the embodiments of the present application, but not all of the embodiments. Based on the embodiments of the present application, all other embodiments obtained by those skilled in the art without any creative efforts fall within the protection scope of the present application.

It should be noted that when an element is said to be “connected” to another element, it may be directly connected to another element, or indirectly connected to another element through one or multiple intermediate elements.

In the specification, the oriental or positional relationships indicated by the terms “longitudinal”, “transverse”, “top”, “bottom”, “inner”, “outer”, “central”, “axial”, “radial”, “circumferential” and the like are only intended to facilitate the description of the present application and simplify the description based on oriental or positional relationships shown in the accompanying drawings, not to indicate or imply that the apparatus or element referred must have a specific orientation, is constructed and operated in a specific orientation, and therefore cannot be understood as a limitation of the present application.

Unless otherwise specified and limited, the specific meanings of all technical and scientific terms used in the specification can be specifically understood by persons of ordinary skill in the art. The terms used in the specification of this application is for the purpose of describing specific embodiments only and is not intended to limit this application.

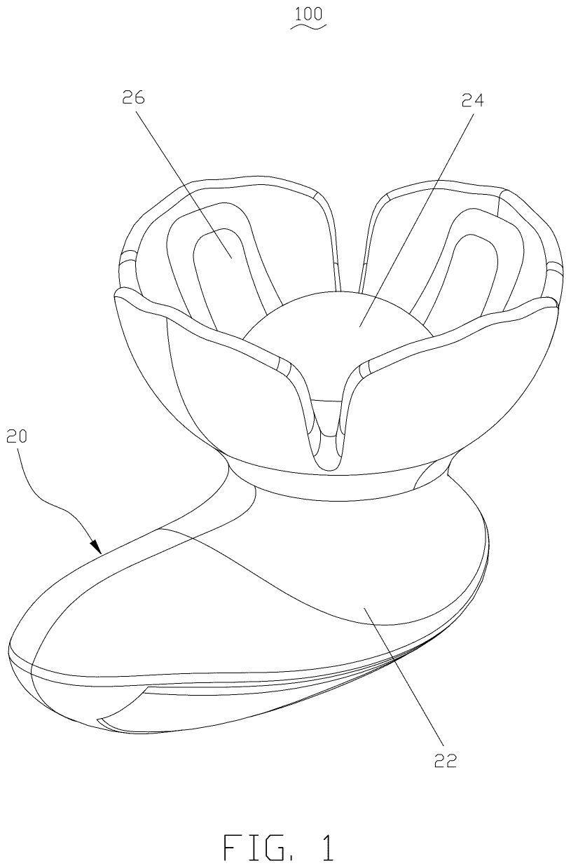

Referring to FIG. 1 to FIG. 7, a massage device according an embodiment of the present application is shown. In this embodiment, the massage device 100 includes a shell 20 and a stimulation modules 30, 40 mounted in the shell 20.

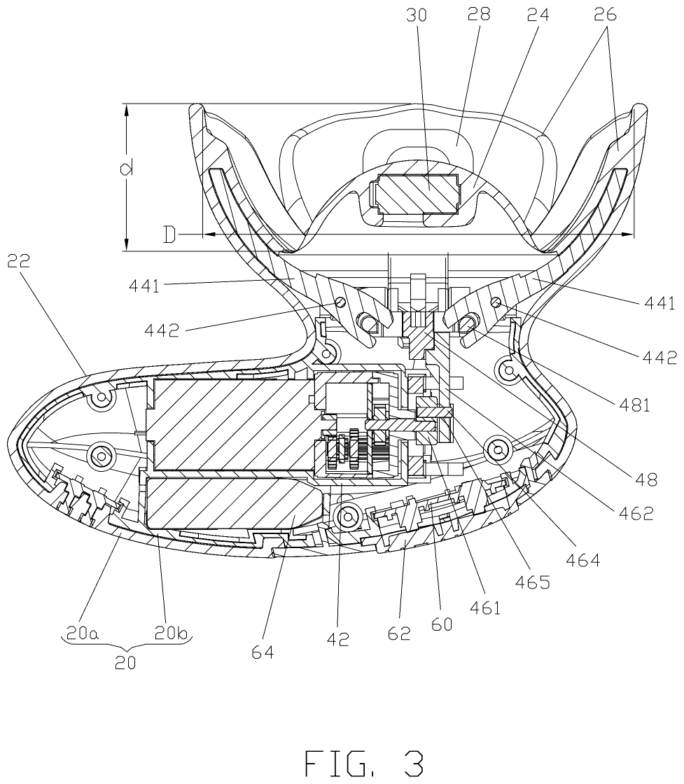

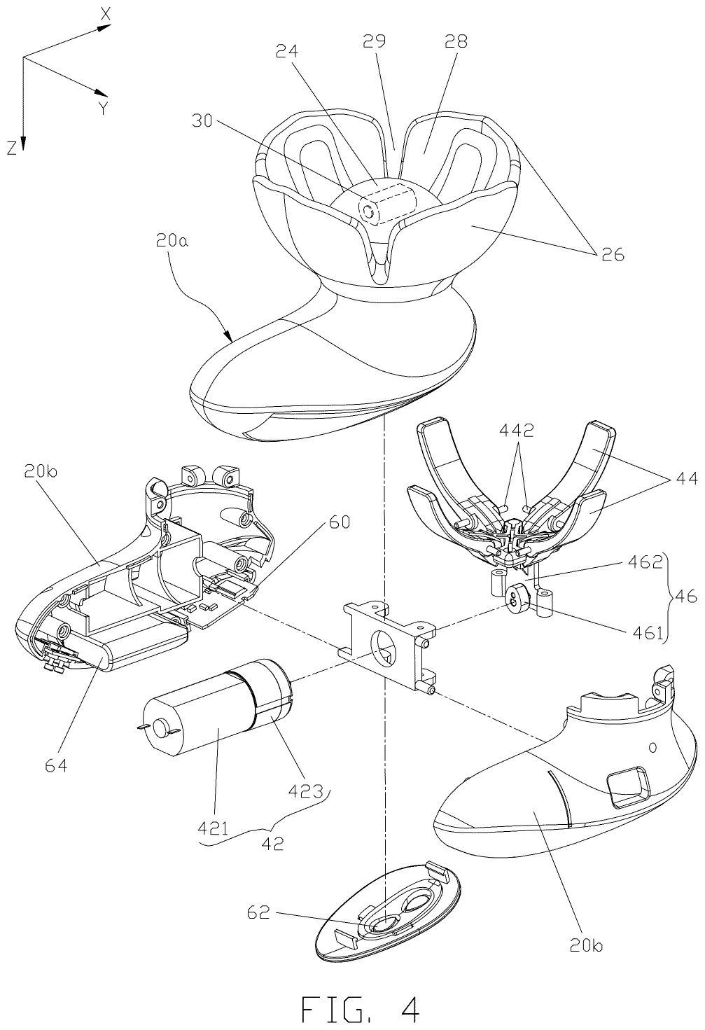

As shown in FIG. 3 and FIG. 4, the shell 20, preferably, is a double-layer structure, and includes an outer shell 20a and an inner shell 20b being fixed inside the outer shell 20a. The inner shell 20b may be made of hard materials, such as plastic, metal and etc., which has a relatively high strength and thus provides support for the stimulation modules 30, 40 mounted inside the shell 20. The outer shell 20a may be made of flexible materials, such as silicone, rubber and etc., for directly contacting a part of the human body which needs to be massaged, so that the massage device 100 of the present application in whole has high strength and comfortable use experience.

In a specific embodiment, the inner shell 20b includes two separate parts, facilitating assembly of components, such as the stimulation modules 30, 40, therein. After assembly of the inner shell 20b and the stimulation modules 30, 40, the outer shell 20a can be formed around the inner shell 20b through over-molding, achieving good sealing effect for the components inside the inner shell 20b. The outer shell 20a is integral and play a waterproof and dustproof role, facilitating cleaning and storage of the massage device 100. In other embodiments, the outer shell 20a may be configured as two parts and then assembled together.

In this embodiment, the shell 20 includes a main portion 22, a first massage portion 24 and a plurality of second massage portions 26. The main portion 22 is configured as a double-layer structure, providing support for the stimulation modules 30, 40 and etc. The second massage portions 26 may be single layer structures, and extend integrally and outwardly from the outer layer of the main portion 22, and the first massage portion 24 is surrounded by and connected to inner ends of the second massage portions 26 integrally. That is, the first massage portion 24, the second massage portions 26 and the outer layer of the main portion 22 cooperatively form the outer shell 20a.

In this embodiment, the first massage portion 24 is configured as a vibration portion, and the second massage portions 26 are configured as swinging portions. Correspondingly, the massage device 100 includes a first stimulation module 30 configured for driving the first massage portion 24 to vibrate and a second stimulation module 40 configured for driving the second massage portions 26 to swing relative to the first massage portion 24.

As shown in FIG. 1, the first massage portion 24 is dome-like, and the second massage portions 26 are sheet-like. In whole, the first massage portions 24 and second massage portions 26 are configured like a flower, wherein the first massage portion 24 is configured as a flower core, and the second massage portions 26 are configured as flowers petals. A chamber 28 is formed among the second massage portions 26 for accommodating a part of the human body, such as the breasts therein. Specifically, a depth “d” of the chamber 28 may be 3-300 mm, and the diameter “D” of the chamber 28 at its open side may be 10-200 mm.

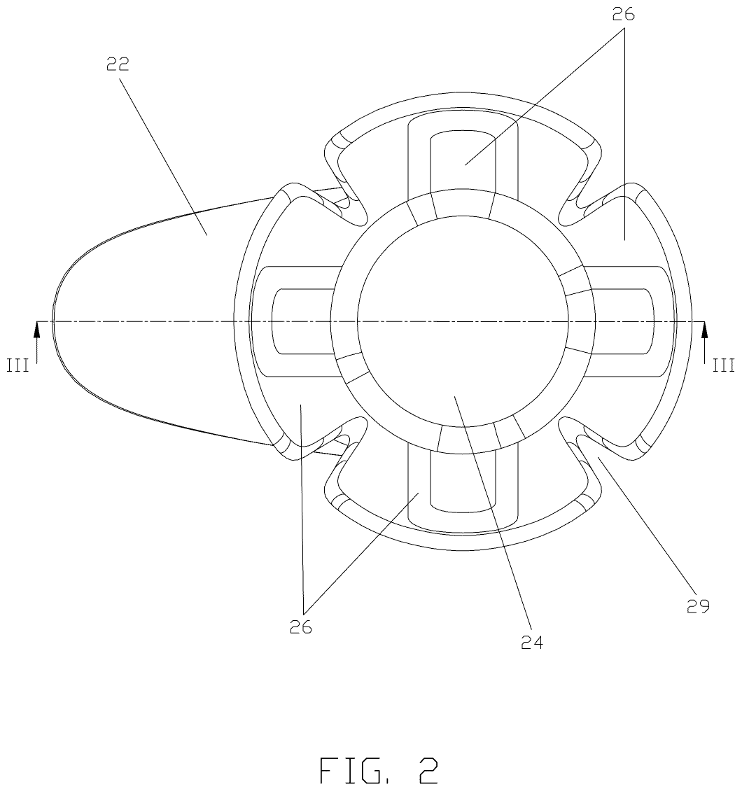

As shown in FIG. 2, the second massage portions 26 are set evenly along a circumferential direction, and a gap 29 is defined between each two neighboring second massage portions 26. Thus, the second massage portions 26 will not interfere with each other during operation. Accordingly, swinging amplitude of the second massage portions 26 may be greater and stimulation to the human body may be stronger. Preferably, outer ends of the second massage portions 26 extend slightly away from each other, the chamber 28 has a size increased gradually and outwardly. In this embodiment, the chamber 28 is generally bowl-shaped, which can fit the shape of the breasts of the human body better.

As shown in FIG. 3 and FIG. 4, the first stimulation module 30 includes at least one vibration motor, which is fixedly embedded in the first massage portion 24 for generating high-frequency vibration to stimulate the part of the human body accommodated inside the chamber 28. When the massage device 100 is used to stimulate the breasts, the vibration motor 30 drives the first massage portion 24 to vibrate, providing stimulation to the nipples, obtaining better stimulation effect.

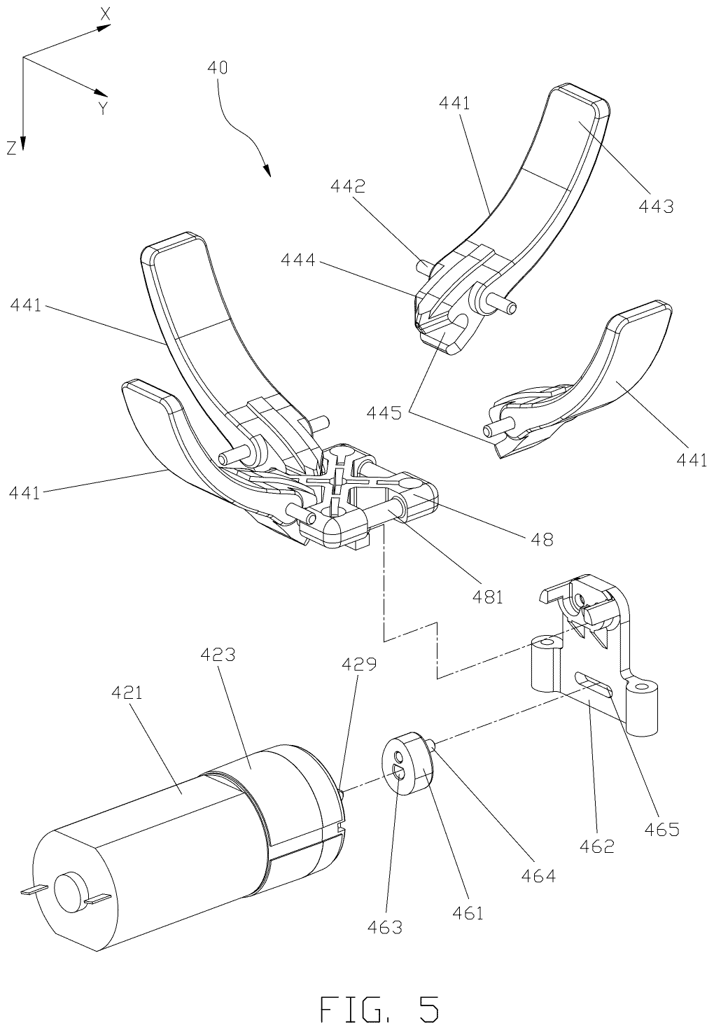

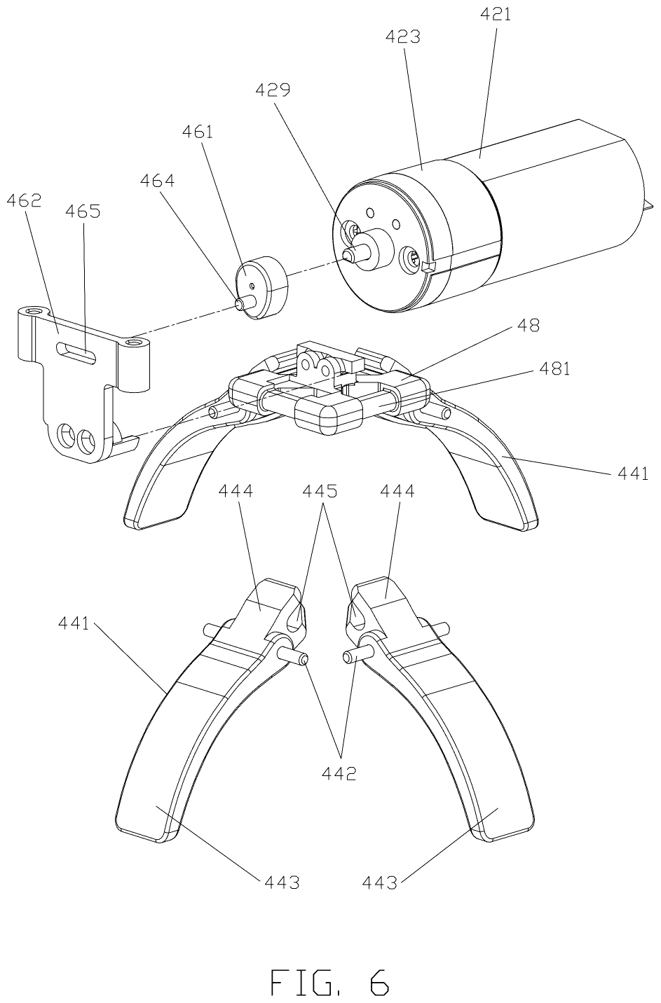

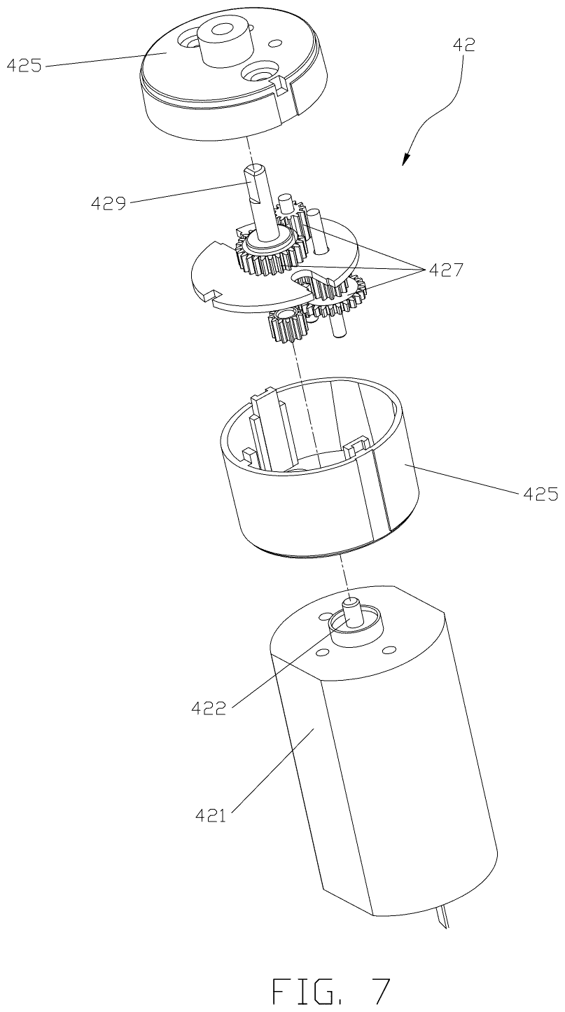

As shown in FIG. 5 and FIG. 6, the second stimulation module 40 includes a gearbox 42, a swinging unit 44, and a transmission unit 46 connected between the gearbox 42 and the swinging unit 44. Referring also to FIG. 7, the gearbox 42 includes a rotary motor 421 and a reduction gear unit 423 connected to the rotary motor 421. The rotary motor 421 serves as a driving component of the second stimulation module 40 and has an output shaft 422 rotating at high-speed.

The reduction gear unit 423 includes a gear housing 425 and a plurality of gears 427 arranged in the gear housing 425. The gears 427 mesh with each other, and a reduction ratio of the whole gearbox 42 can be determined according to the gear ratios between the meshed gears 427. The reduction gear unit 423 has an output shaft 429 serving as an output shaft of the gearbox 42. Under the reduction effect of the gears 427, a speed of the output shaft 429 does not exceed 1000 rpm.

The transmission unit 46 is configured for converting rotation of output shaft 429 of the gearbox 42 into reciprocating linear movement. In this embodiment, the transmission unit 46 includes an eccentric wheel 461 and a sliding member 462.

The eccentric wheel 461 is connected to the output shaft 429 at a central portion thereof. In this embodiment, the eccentric wheel 461 defines a central hole 463 for inserting of the output shaft 429 therein. The central hole 463 is non-circular shaped, such as D-shaped, and a cross section of the output shaft 429 has a shape matching with that of the central hole 463. After inserting of the output shaft 429 into the central hole 463, a relative rotation therebetween is limited for shape fitting, thereby the eccentric wheel 461 can rotate along with the output shaft 429 of the gearbox 42.

An eccentric rod 464 is set eccentrically on the eccentric wheel 461 and extends towards the sliding member 462. Generally, the eccentric rod 464 is parallel to the output shaft 429 of the gearbox 42. In this embodiment, as shown in FIG. 5, the eccentric rod 464 and the output shaft 429 both extends along X-direction. During rotation of the eccentric wheel 461 along with the output shaft 429, the eccentric rod 464 revolves round the output shaft 429 in YZ plane. In other words, under the driving of the gearbox 34, the eccentric rod 464 generates displacements in both Y-direction and Z-direction.

The sliding member 462 defines a sliding groove 465 therein, which is generally strip-shaped and elongated in a direction perpendicular to the eccentric rod 464, such as the Y-direction. The eccentric rod 464 engages into the sliding groove 465, and is fixed relative to the sliding member 462 in the Z-direction whilst is slidable relative to the sliding member 462 in the Y-direction. During revolving of the eccentric rod 464 round the output shaft 429, its displacement in the Y-direction makes it slide relative to the sliding member 462 along the sliding groove 465, while its displacement in the Z-direction drives the sliding member 462 to move along with it in the Z-direction.

By means of the cooperation of the eccentric rod 464 of the eccentric wheel 461 and the sliding groove 465 of the sliding member 462, rotation of the gearbox 42 is converted into reciprocating linear motion of the sliding member 462 in the Z-direction.

The swinging unit 44 includes multiple swinging bars 441 arranged around the sliding member 462. Each of the swinging bars 441 is rotatably connected to the shell 20, preferably the inner shell 20b, by a first pivot 442. In this embodiment, the swinging bar 441 is generally sheet-like and elongated in the Z-direction. One end of the swinging bar 441, preferably an end away from the first pivot 442, is configured as a swinging end 443 and extends into one of the second massage portions 26 of the shell 20; and, another end of the swinging bar 441, preferably an end adjacent to the first pivot 442, is configured as a connecting end 444 and connected to the sliding member 462.

The first pivots 442 extend perpendicular to the Z-direction, wherein some of the first pivots 442 extend along the X-direction, and some of the first pivots 442 extend along the Y-direction. When the sliding member 462 moves in the Z-direction, the swinging bars 441 are driven to swing about the first pivots 442, respectively. That is, the swinging bars 441 swing in the XZ plane or YZ-plane. The swinging ends 443 of all of the swinging bars 441 swing towards or away from each other synchronously, achieving an occlusion action to knead the part of the human body entering the chamber 28 and covered by the swinging bars 441.

Further, a sliding frame 48 is provided inside the shell 20 for rotatably connecting the swinging bars 441 to the sliding member 463. In this embodiment, the sliding frame 48 is generally constructed as a polygon structure with a number of lateral edges the same as the number of the swinging bars 441/second massage portions 26. The connecting end 444 of each swinging bar 441 is rotataly connected to a lateral edge of the sliding frame 48 by a second pivot 481. Each second pivot 481 is set to be generally parallel to a corresponding first pivot 442 for the same swinging bar 441.

The sliding frame 48 may be formed separately and then assembled to the sliding member 462, or, may be integrally formed with the sliding member 462 as one piece, as long as the sliding frame 48 can move together with the sliding member 462. In this embodiment, the second pivot 481 is integrally formed with the sliding frame 48 as one piece, and a U-shaped groove 445 is defined in the connecting end 444 of the swinging bar 441 for facilitating assembly of the second pivot 481 and the swinging bar 441. It should be understood that, in other embodiment, the second pivot 481 may be formed separately and then assembly to the sliding frame 48 and/or swinging bar 441.

In this embodiment, as shown in FIG. 5, the sliding frame 48 is generally square-shaped, and four swinging bars 441 are provided to connect four lateral edges of the sliding frame 48, respectively. Correspondingly, the shell 20 includes four second massage portions 26 arranged around the first massage portion 24 for accommodating the swinging ends 443 of the four swinging bars 441 therein, respectively. It should be noted that the number of the second massage portions and/or swinging bars are not limited to be four as the above embodiment.

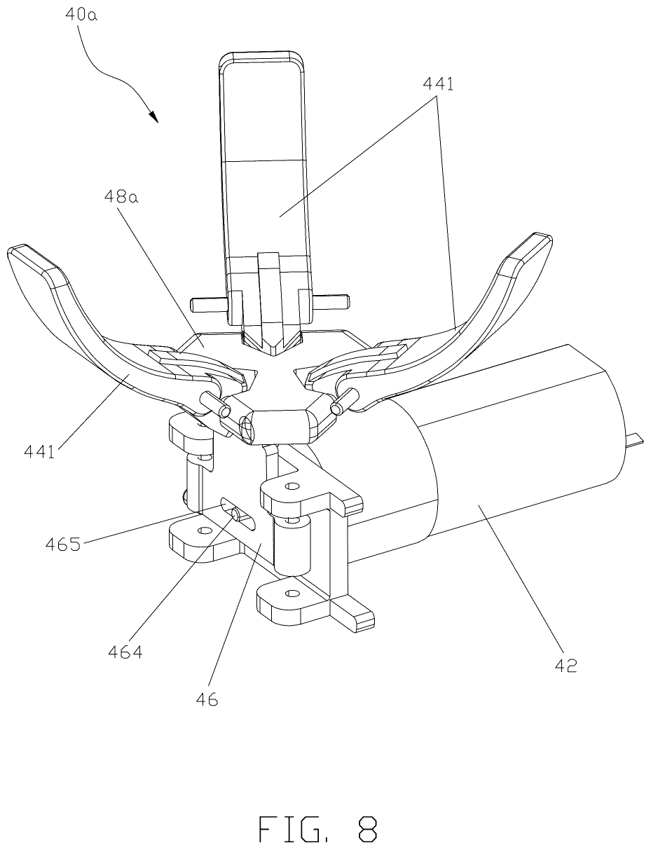

FIG. 8 shows a second stimulation module 40a of a massage device according to an alternative embodiment. In this embodiment, the second stimulation module 40a includes three swinging bars 441 connected to the transmission unit 46 by a sliding frame 48a which is generally hexagonal-shaped. Preferably, the massage device may have 3-8 swinging bars 441, such as five or six swinging bars 441. Correspondingly, there may be 3-8 second massage portions 26. The sliding frame 48 may be configured with a number of lateral edges the same or larger than that of the swinging bars 441/second massage portions 26.

During operation, the sliding member 462 and the sliding frame 48 move together in the Z-direction under the driving of the gearbox 42, and in turn drives the swinging bars 441 to swing about the first pivots 442 relative to the shell 20, and swing about the second pivots 481 relative to the sliding frame 48 at the same time, thereby the swinging ends 443 and the second massage portions 26 swinging towards or away from the first massage portion 24 to knead the human body, which is similar to a pinch motion of the human hand, providing a more comfortable sexual stimulation, and thus the users are more likely to reach orgasm with the help of the present massage device 100.

In this embodiment, the first pivot 442 is adjacent to the connecting end 444 and away from the swinging end 443 of the swinging bar 441, so that the swinging end 443 of the swinging bar 441 rotates about the first pivot 442 can get a greater swing amplitude even if a swinging angle of the swinging bar 441 rotating about the second pivot 481 is small. Accordingly, the second massage portions 26 driven by the swinging bars 441 can provide an enhanced stimulation to the human body.

Referring to FIG. 3 and FIG. 4 again, a controller, such as a control circuit board 60 is mounted in the shell 20 and electrically connected to the rotary motor 421 and vibration motor 30 for controlling their operation according to user's instructions, such as controlling the vibration frequency of the vibration motor 30, controlling the rotary speed of the rotary motor 42, and etc. Control buttons 62, such as mechanical buttons or touch buttons, may be provided on the outer shell 20a for input the user's instructions. Further, a battery 64, preferably a rechargeable battery, is arranged in the main portion 22 of the shell 20 and electrically connected to electric components, such as the rotary motor 421, the vibration motor 30, and etc., through the control circuit board 60 for supplying electric power.

During operation, the second stimulation module 40 may be started separately to achieve a stimulation effect to the human body, such as the breasts, through swinging of the second massage portions 26; or, the first stimulation module 30 may be started separately to achieve a stimulation effect to the human body through the high-frequency vibration of the first massage portion 24; or, the first and second stimulation modules 30, 40 may be started at the same time to provide a multi-stimulation effect to the human body. For enhance user comfort, the second massage portions 26 and the first massage portion 24 of the shell 20 are constructed as a soft single-layer structure, i.e., without the hard inner shell 24.

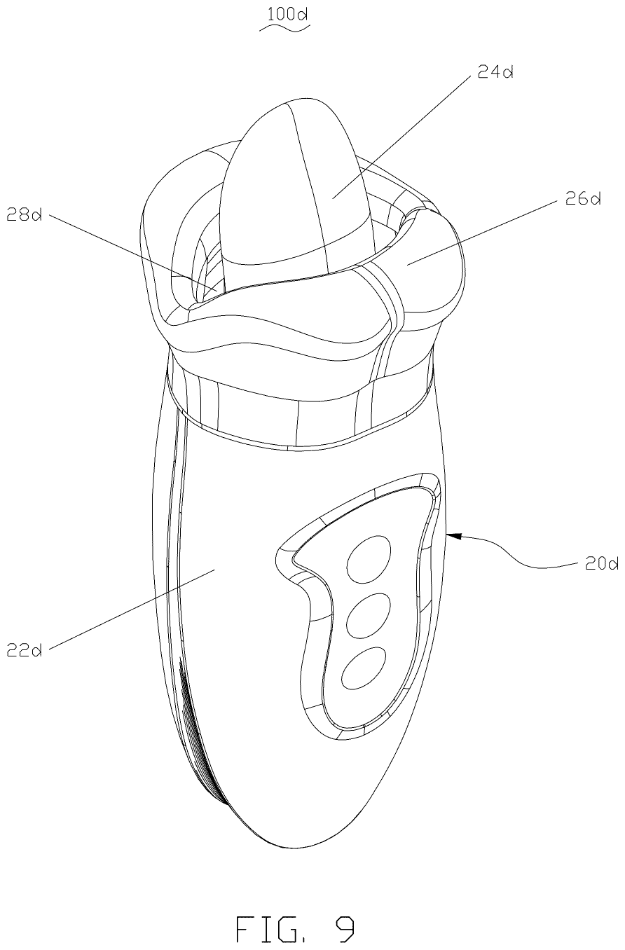

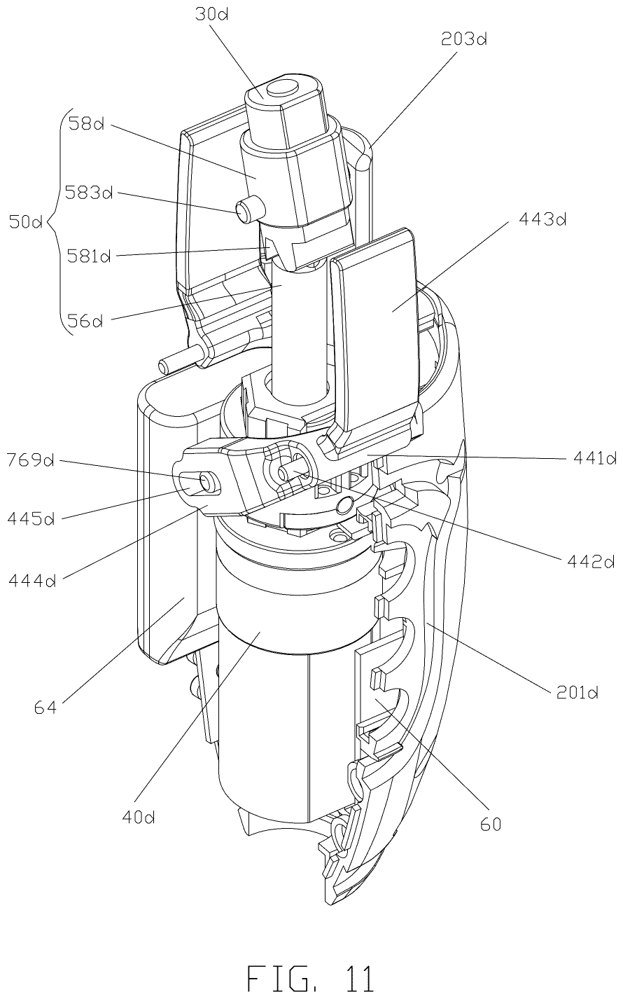

FIGS. 9-12 show a massage device according to a third embodiment of the present application. In this embodiment, the massage device 100d includes a shell 20d and stimulation modules 30d, 40d, 50d mounted in the shell 20d.

The shell 20d includes a main portion 22d, a first massage portion 24d and two second massage portions 26d. The first massage portion 24d is configured as a tongue, and the second massage portions 26d are arranged at two opposite sides of the first massage portion 24d. A chamber 28d is defined between the second massage portions 26d, and the first massage portion 24d extends partly beyond the chamber 28d. In this embodiment, the two second massage portions 26d are connected with each other in a circumferential direction, and in whole are configured as a month. Preferably, connecting positions of the two second massage portions 26d are generally V-shaped.

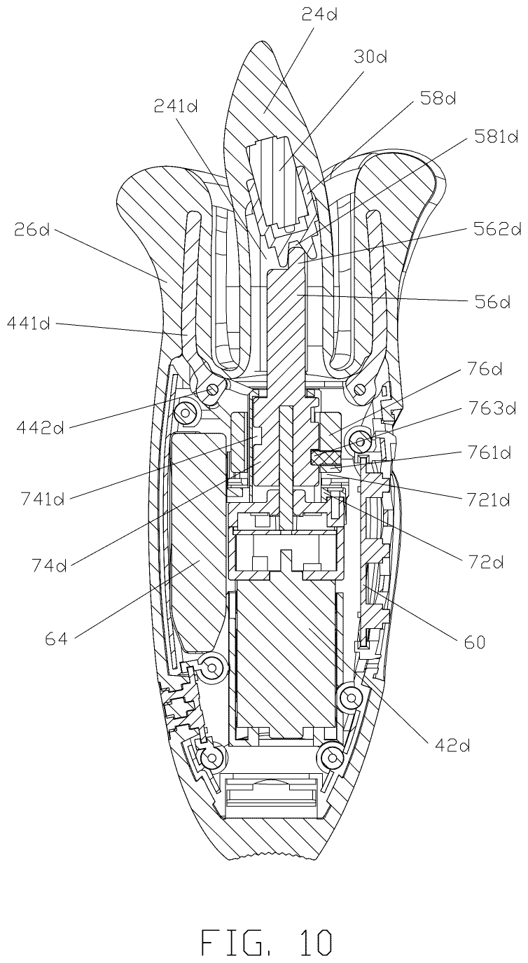

As shown in FIG. 10, a first stimulation module 30d, such as a vibration motor is provided inside the first massage portion 24d of the shell 20d for driving the first massage portion 24d to vibrate; a second stimulation module 40d is configured for driving the second massage portions 26d to swing towards or away from the first massage portion 24d; and a third stimulation module 50d is configured for driving the first massage portion 24d to swing.

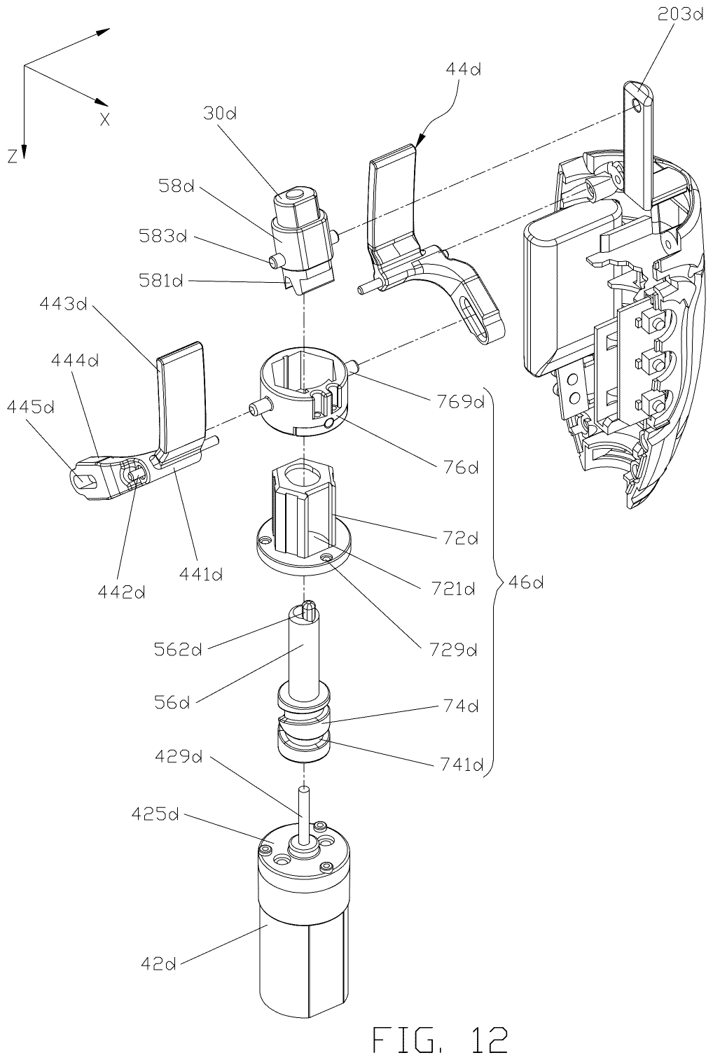

As shown in FIG. 12, the second stimulation module 40d includes a gearbox 42d, a swinging unit 44d, and a transmission unit 46d connected between the gearbox 42d and the swinging unit 44d for converting rotation of the gearbox 42d into reciprocating linear movement.

The transmission unit 46d includes a fixed member 72d defining a first sliding groove 721d therein, a rotary member 74d defining a second sliding groove 741d therein, and a sliding member 76d configured with a first sliding portion 761d being slidably engaged into the first sliding groove 721d and a second sliding portion 763d being slidably engaged into the second sliding groove 741d (refereeing to FIGS. 10 and 12). The first sliding groove 721d of the fixed member 72d is elongated in the Z-direction, and the second sliding groove 741d of the rotary member 74d extends spirally in the circumferential direction.

In this embodiment, through holes 729d are defined at an end (such as a bottom end) of the fixed member 72d, and fixing components, such as screws, extend through the through holes 729d to fix the fixed member 72d into the shell 20d, such as fix onto a gear housing 425d of the gearbox 42d. The rotary member 74d is configured as a rotary shaft, being rotatably mounted in the fixed member 72d and connected to an output shaft 429d of the gearbox 42d in a transmission way. The sliding member 76d is configured as a hollow sleeve, and mounted around the fixed member 72d. Two connecting rods 769d extend radially and outwardly from the sliding member 76d.

The swinging unit 44d includes two swinging bars 441d arranged at two opposite sides of the sliding member 76d, respectively. Each swinging bar 441d is rotatably connected to the shell 20d, particularly an inner shell 201d, by a first pivot 442d, wherein the first pivot 442d is parallel to the connecting rod 769d. An end of the swinging bar 441d away from the first pivot 442d is configured as a swinging end 443d and extends into one of the second massage portions 26d of the shell 20d; and, another end of the swinging bar 441d adjacent to the first pivot 442d is configured as a connecting end 444d for connecting the sliding member 76d.

In this embodiment, the connecting end 444d of each swinging bar 441d defines an elongated slot 445d therein. Each connecting rod 769d is movably and rotataly engaged into the elongated slot 445d of one corresponding swinging bar 441d, thereby the sliding member 76d can drive the connecting ends 444d of the swinging bars 441d to do reciprocating movement in the Z-direction synchronously, which in turn drives the swinging bars 441d to rotate about the corresponding first pivots 442d in opposite directions, respectively; and finally drives the swinging ends 443d and the second massage portions 26d to swing towards or away from the first massage portion 24d.

As shown in FIG. 12, the third stimulation module 50d includes a driving rod 56d, a swinging component 58d and a driving component such as a rotary motor, a gearbox and the like. The driving rod 56d is connected to the driving component in a transmission way, and is driven to rotate about a rotary axis which extends along the Z-direction. An eccentric rod 562d is set eccentrically on the driving rod 56d and extends towards the swinging component 58d. The swinging component 58d defines an elongated groove 581d for receiving the eccentric rod 562d, wherein the elongated groove 581d extends in a direction (such as the Y-direction) perpendicular to the rotary axis of the driving rod 56d.

The swinging component 58d is rotatably connected to the shell 20d by a third pivot 583d, wherein the third pivot 583d extends along the Y-direction, parallel to and spaced from the elongated groove 581d. During operation, the eccentric rod 562d is driven to revolve round the rotary axis of the driving rod 56d, its displacement in the Y-direction makes it slide relative to the swinging component 58d along the elongated groove 581d, while its displacement in the X-direction drives the swinging component 58d to move along with it in the X-direction, thereby making the swinging component 58d and the first massage portion 24d swing about the third pivot 583d in the XZ-plane.

As shown in FIG. 10, the first massage portion 24d defines a cavity 241d for receiving the swinging component 58d therein. Preferably, two support arms 203d extend from the inner shell 201d into the cavity 241d for support two ends of the third pivot 583d, respectively. Preferably, the swinging component 58d has an upper portion being embedded inside the first massage portion 24d, and a lower portion on which third pivot 583d and the elongated groove 581d are provided accommodated in the cavity 241d. The driving rod 56d extends into the cavity 241d, and the eccentric rod 562d is slidably inserted in the elongated groove 581d of the swinging component 58d.

Preferably, the swinging component 58d is made of hard materials, and the first stimulation device 30d is mounted in the swinging component 58d, and thus can swing together with the swinging component 58d and the first massage portion 24d. Therefore, the first massage portion 24d can not only stimulate the human body through high-frequency vibration caused by the first stimulation module 30d, but also knead the human body through swinging caused by the third stimulation module 50d, further enhancing the stimulation effect of the first massage portion 24d.

In this embodiment, the driving rod 56d is integrally formed on a top end of the rotary member 74d, and the gearbox 42d further serves as the driving component of the third stimulation module 50d. In other embodiments, the driving rod 56d may be formed separately and then connected to the gearbox 42d directly or indirectly. In other embodiments, another gearbox may be provided to drive the driving rod 56d to rotate, thereby the swinging motion of the first massage portion 24d can be controlled separately.

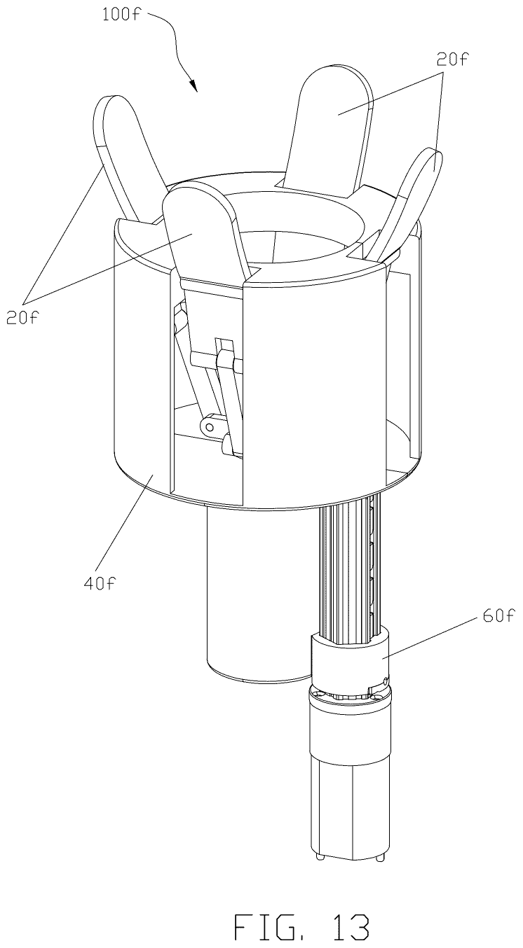

FIGS. 13-16 show a massage device according to a fourth embodiment of the present application. In this embodiment, the massage device 100f includes a swinging unit configured with a plurality of swinging bars 20f, a first stimulation unit 40f connected to the swinging bars 20f, and a second stimulation unit 60f connected to the first stimulation unit 40f.

The swinging bars 20f are arranged around an axis C0, and cooperatively defines a chamber 22f taking the axis C0 as its central axis. The chamber 22f is configured for accommodating a part of the human body, such as the male penis, the arm, the finger, and etc., which needs to be massaged therein. In the illustrated embodiment, there are four swinging bars 20f, being evenly spaced from each other in a circumferential direction of the chamber 22f. In other embodiments, the number of swinging bars 20f may be, for example, two, three, five, six, and etc.

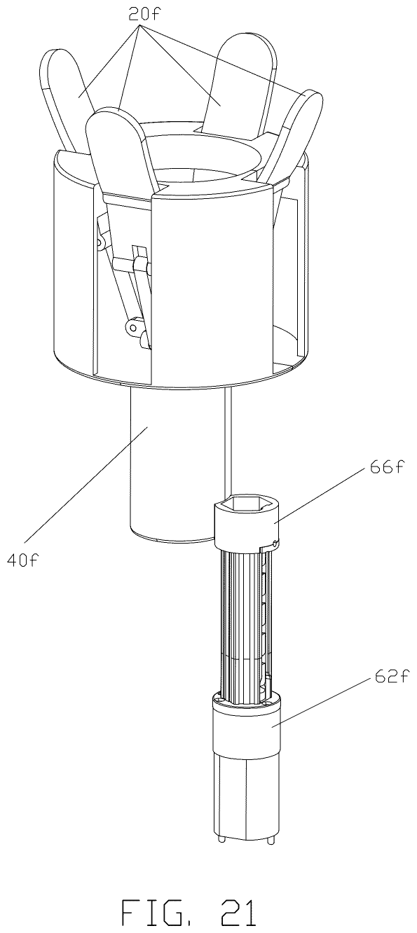

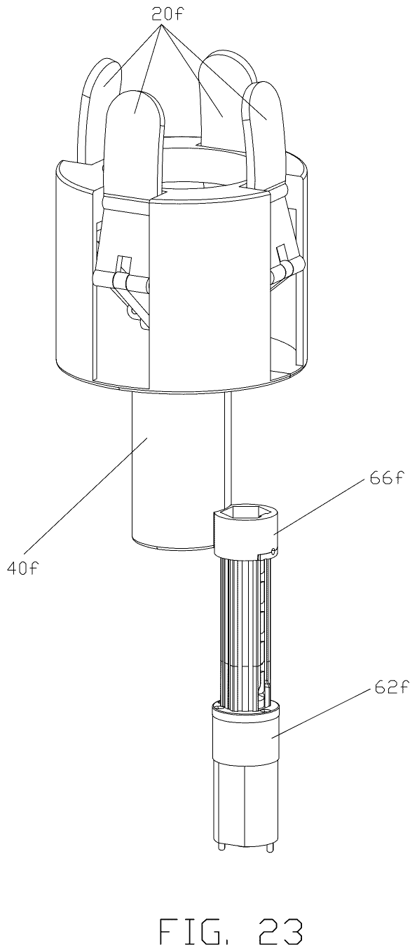

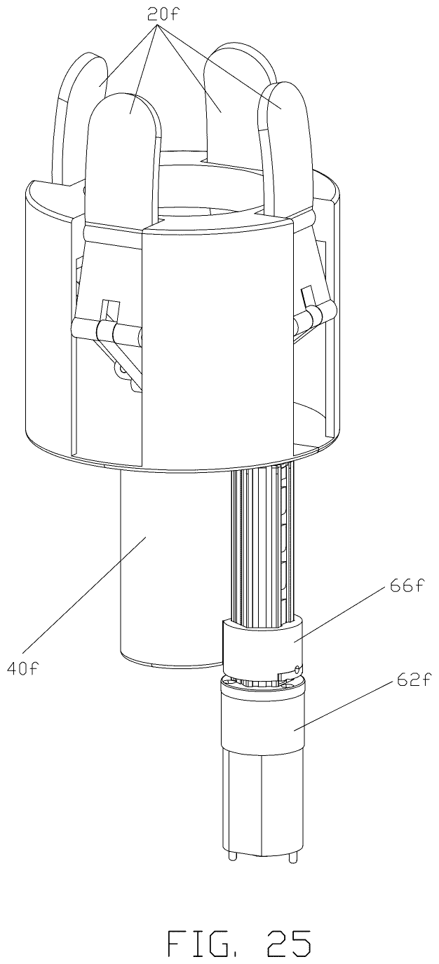

The first stimulation unit 40f is configured for driving the swinging bars 20f of the swinging unit to move in a radial direction of the chamber 22f, i.e., move towards or away from the central axis C0, so that the swinging unit has two different states, namely open state (refereeing to FIG. 13 and FIG. 21) and clamping state (refereeing to FIG. 23 and FIG. 25). The second stimulation unit 60f is configured for driving the swinging unit and the first stimulation unit 40f to move together in an axial direction of the chamber 22f, i.e., move along the axial direction of the chamber 22f between two different positions, i.e., first position P1 and second position P2.

By means of changing the position and/or state of the swinging unit, clamping and pulling may be applied onto the part of the human body inside the chamber 22, resulting in better stimulation effect and user experience.

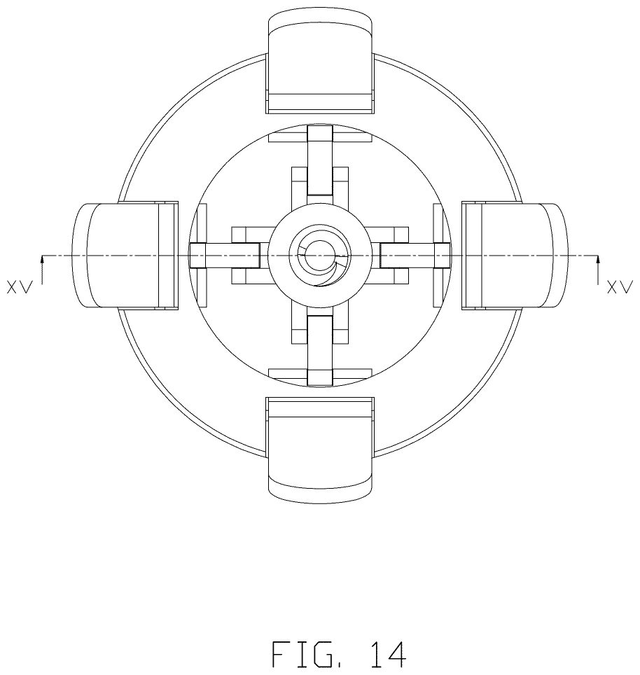

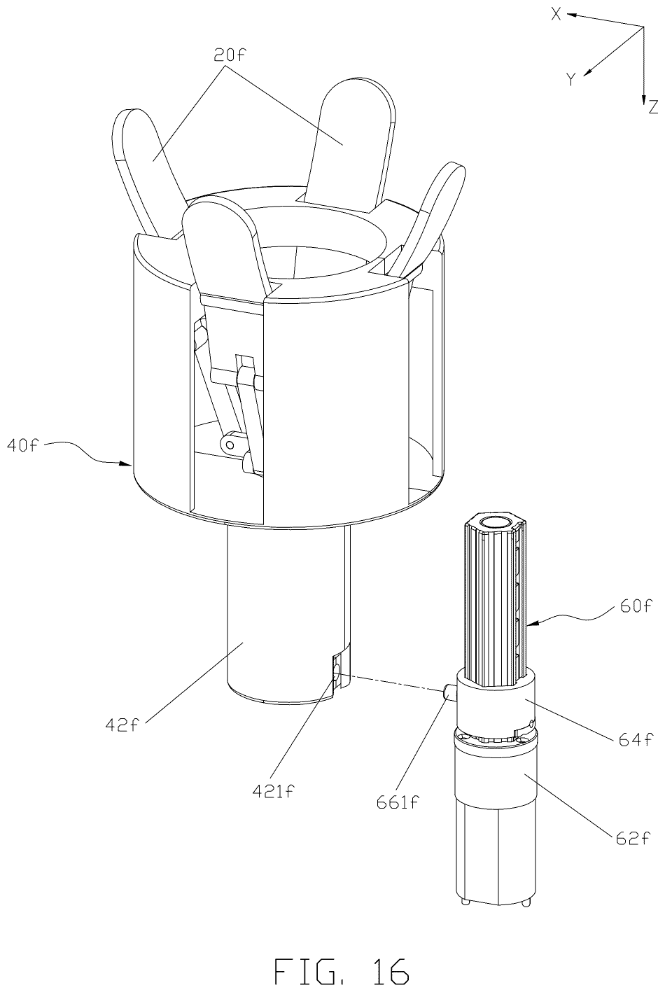

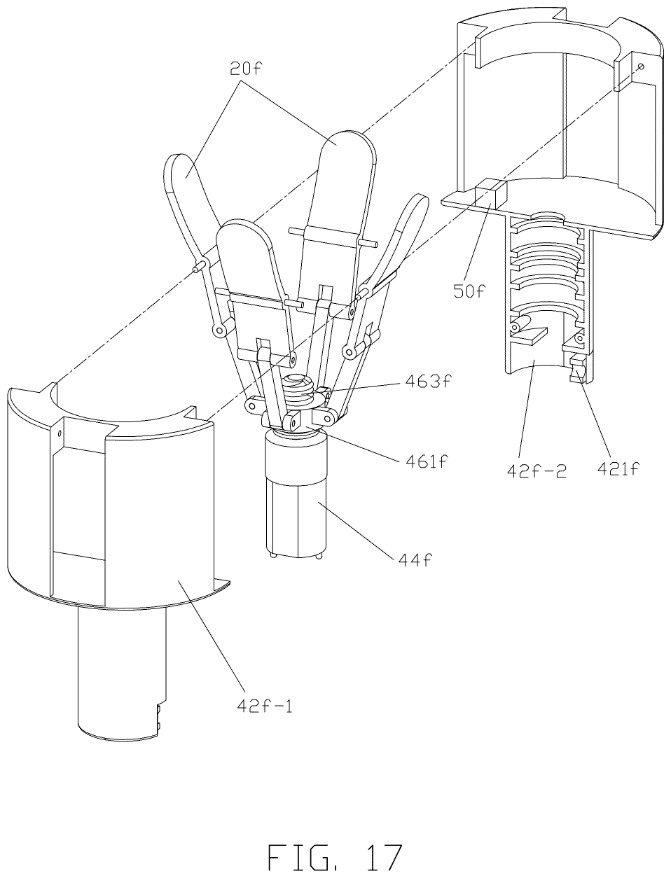

As shown in FIGS. 16-18, the first stimulation unit 40f includes a mounting seat 42f, a first driving member 44f set in the mounting seat 42f, and a first transmission unit 46f connected between the first driving member 44f and the swinging bars 20f of the swinging unit. As shown in FIG. 14, the mounting seat 42f is preferably formed by assembly of two separate parts 42f-1, 42f-2 together, so as to facilitate the assembly of the swinging bars 20, the first driving member 44f, the first transmission assembly 46f, and etc. into the mounting seat 42f.

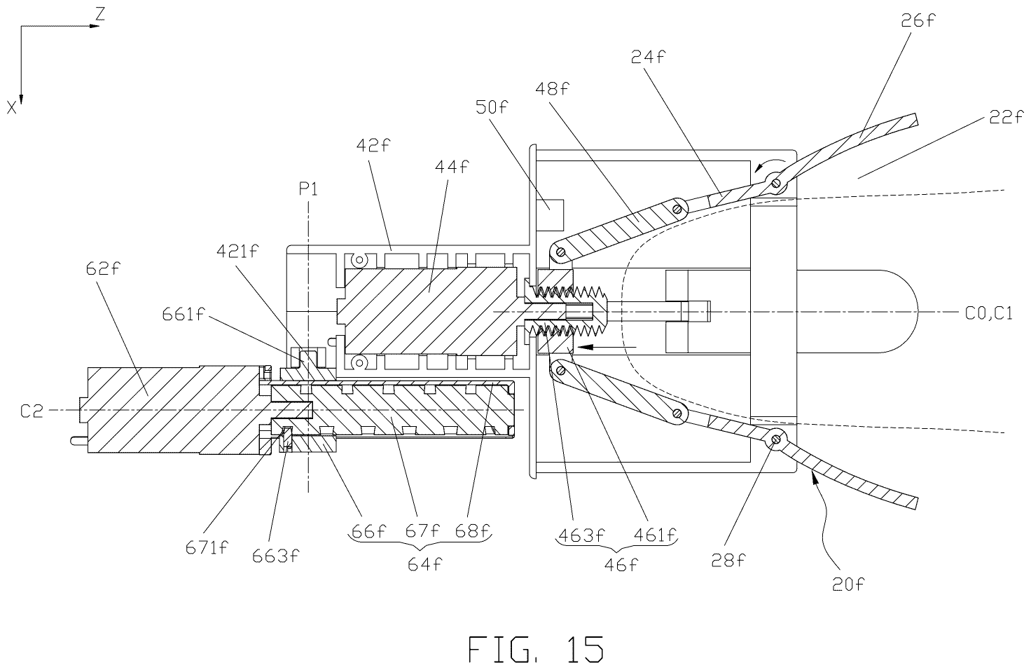

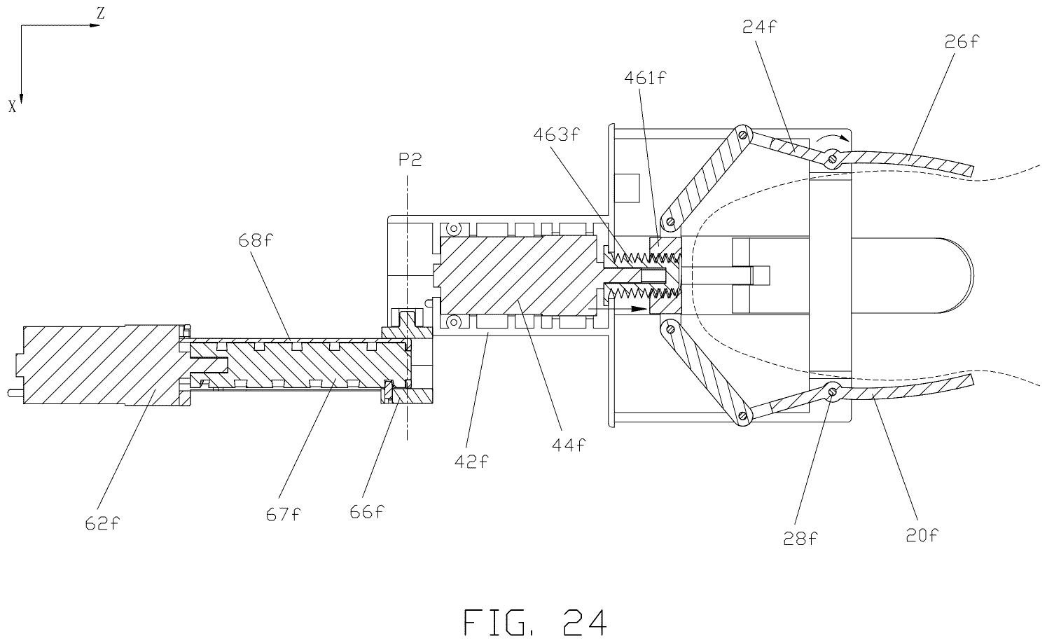

Each swinging bar 20f is generally elongated and arc-shaped, and has a connecting end 24f and a swinging end 26f that are opposite to each other. The connecting end 24f is, preferably, rotatably connected to the first transmission unit 46f. The swinging end 26f extends beyond the mounting seat 42f for clamping the portion of the human body, such as the male penis inserted into the chamber 22f. As shown in FIGS. 23-24, when the swinging ends 26f move towards the central axis C0, the swinging unit switches to the clamping state, so as to clamp male penis; on the contrary, as shown in FIG. 13 and FIG. 15, when the swinging ends 26f move away from the central axis C0, the swinging unit switches to the open state and releases male penis.

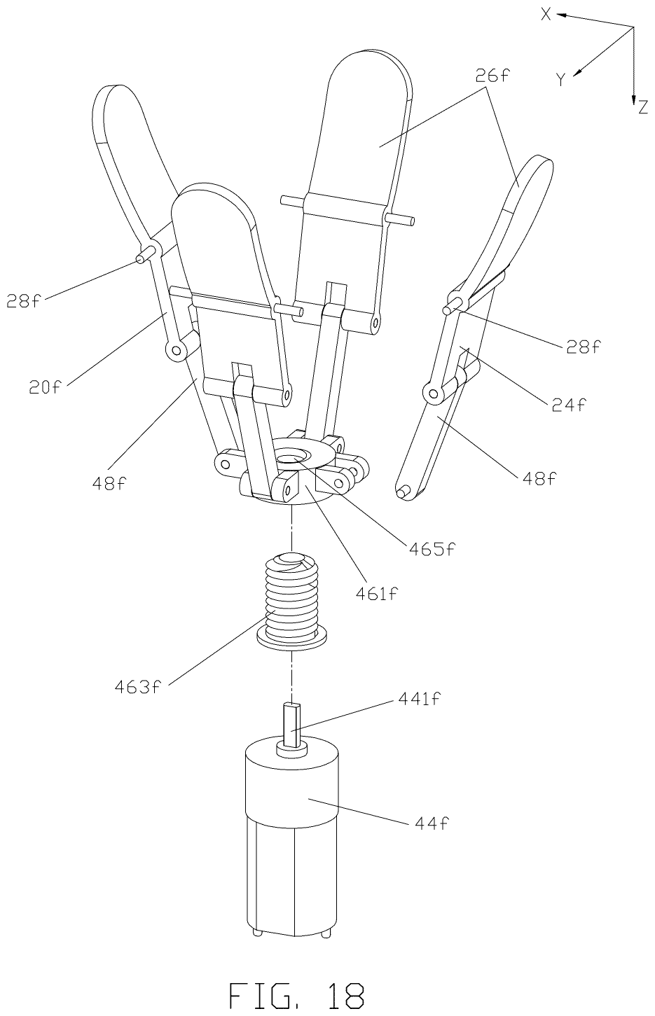

In this embodiment, a middle portion of each swinging bar 20f is rotatably connected to the mounting seat 42f through a first pivot 28f, wherein the first pivot 28f extends perpendicular to the central axis C0 of the chamber 22f. Referring to the coordinate system in FIGS. 16 and 18, the central axis C0 extends in Z-direction, and the first pivot 28f extends in XY-plane. Specifically, there may be one or multiple first pivots 28f extending along the X-direction, one or multiple first pivots 28f extending along the Y-direction, and one or multiple first pivots 28f at an angle relative to the X-direction and Y-direction.

The first driving member 44f may be a rotary motor, preferably a gear motor, which has a first output shaft 441f being configured to drive the swinging bars 20f to swing towards or away from each other taking the first pivots 28f as the swinging axes, respectively. The first pivot 28f may be fixedly connected to the swinging bar 20f and rotatably connected to the mounting seat 42f; or, the first pivot 28f may be fixedly connected to the mounting seat 42f and rotatably connected to the swinging bar 20f.

It should be understood that the swinging bars 20f are rotatably connected to the mounting seat 42f, and are driven by the first driving member 44f to swing relative to the mounting seat 42f about the first pivots 28f, realizing state changing of the swinging unit. In other embodiments, the swinging bars 20f may be configured to be slidable relative to the mounting seat 42f, and the first driving member 44f drives the swinging bars 20f to slide radially towards or away from the central axis C0, which can also achieve state changing of the swinging unit.

In this embodiment, the first transmission unit 46f includes a connecting base 461f and a screw rod 463f cooperating with the connecting base 461f. The first driving member 44f is configured to drive the connecting base 461f to move along the central axis C0. The connecting ends 24f of the swinging bars 20f are arranged around the connecting base 461f and rotatably connected to the connecting base 461f, respectively. When the connecting base 461f moves along the central axis C0, the swinging bars 20f swing towards or away from each other, taking the corresponding first pivots 28f as the swinging axes, respectively.

As shown in FIGS. 23-24, when the connecting base 461f moves along the central axis C0 towards an end where the swinging ends 26f of the swinging bars 20 are located, the swinging ends 26f swing towards the central axis C0, so that the swinging unit is changed to the clamping state. On the contrary, as shown in FIG. 13 and FIG. 15, when the connecting base 461f moves along the central axis C0 away from the end where the swinging ends 26f are located, the swinging ends 26f swing away from the central axis C0, so that the swinging unit is changed to the open state.

In this embodiment, a flexible outer layer made of silicone or the like may be covered on the mounting seat 42f and the swinging bars 20f, especially on the swinging ends 26f of the swinging bars 20f. The flexible outer layer, may be regarded as an outer layer of a shell of the massage device 100f, and the mounting seat 42f may be regarded as a portion of an inner layer of the shell of the massage device 100f, wherein portions of the flexible outer layer on the swinging ends 26f of the swinging bars 20f may be regarded as massage portions of the shell of this massage device 100f.

The screw rod 463f is connected to and driven by the first output shaft 441f of the first driving member 44f to rotate about a first axis C1. The first axis C1 may be parallel to or collinear with the central axis C0 of the chamber 22f, preferably collinear with the central axis C0. In the illustrated embodiment, the screw rod 463f is directly connected to the first output shaft 441f of the first driving member 44f. Preferably, the first output shaft 441f has a non-circular cross-section, and the screw rod 463f forms a corresponding hole in which the screw rod 463f is inserted. The screw rod 463f and the first output shaft 441f are fixed in the circumferential direction through shape-fitting, so as to rotate synchronously.

In other embodiments, the screw rod 463f and the first output shaft 441f may be fixed in the circumferential direction for synchronous rotation through other means, such as bonding, tight fitting, and etc. In addition, the screw rod 463f and the first output shaft 441f may be connected together through other connecting components such as shaft coupling. Furthermore, transmission components such as gears, pulleys, and etc. may be configured between the screw rod 463f and the first output shaft 441f to achieve long-distance and/or directional transmission of power, facilitating the arrangement of the first driving member 44f.

In this embodiment, a screw hole 465f is defined in a central portion of the connecting base 461f, so that the screw rod 463f can be connected to the connecting base 461f through screw connection. Through cooperation of the screw rod 463f and the screw hole 465f of the connecting base 461f, the rotary motion of the first driving member 44f is converted into linear movement of the connecting base 461f along the central axis C0.

In this embodiment, a controller 50f may be set inside the mounting seat 42f, for controlling the rotary direction and/or speed of the first driving member 44f according to the position and/or state of the swinging unit, so that the connecting base 461f can be driven to move back and forth along the central axis C0.

It should be understood that the first transmission unit 46f is used to convert the rotational motion of the first driving member 44f into linear movement of the connecting base 461f, thereby driving the swinging bars 20f to swing towards or away from each other. In other embodiments, the first transmission unit 46f may have other structures, such as gears and racks, as long as it can drive the connecting base 461f to move along the central axis C0, thereby driving the swinging bars 20f to move towards or away from the central axis C0, producing a clamping effect on the male penis.

In the illustrated embodiment, the connecting end 24f of each swinging bar 20f is connected to the connecting base 461f via a connecting rod 48f. Preferably, two ends of each connecting rod 48f are hinged to the connecting base 461f and the connecting end 24f of the corresponding swinging bar 20f by two second pivots, respectively. In this way, when the connecting base 461f moves in the axial direction, the connecting rod 48f rotates relative to the connecting base 461f, and at the same time, the swinging bar 20f rotates relative to the connecting rod 48f, making the swinging of the swinging bar 20f about the first pivot 28f smoother.

In some embodiments, there may be several connecting rods 48f hinged between each swinging bar 20f and the connecting base 461f. In some embodiments, the connecting rod 48f may be omitted.

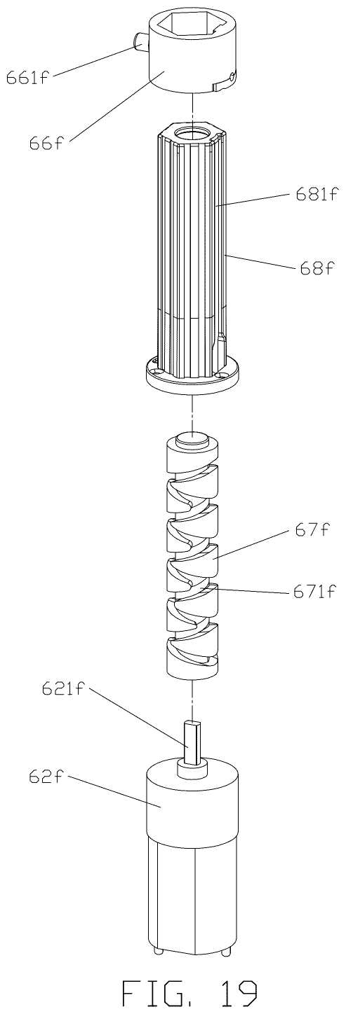

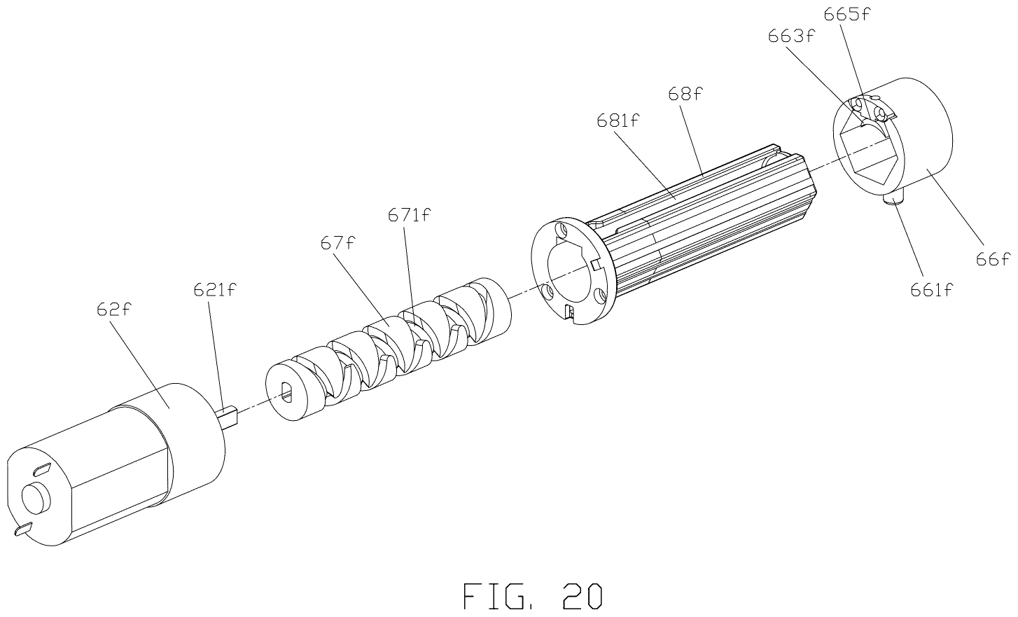

As shown in FIGS. 16 and 19-20, the second stimulation unit 60f includes a second driving member 62f and a second transmission unit 64f connected between the second driving member 62f and the mounting seat 42f of the first stimulation unit 40f, wherein the second driving member 62f may be a motor, preferably a gear motor.

The second transmission unit 64f includes a sliding member 66f and a rotary member 67f that cooperate with each other, wherein the rotary member 67f is connected to a second output shaft 621f of the second driving member 62f and is driven to rotate around a second axis C2. As shown in FIG. 15, the second axis C2f extends in Z-direction, being parallel to the central axis C0. In other embodiments, the second axis C2f may be collinear with the central axis C0.

The sliding member 66f is non-rotatably set in the massage device 100f, and a first sliding portion 663f is provided on the sliding member 66f. Correspondingly, a spiral-shaped first sliding groove 671f is provided on an outer circumferential surface of the rotary member 67f. The first sliding portion 663f engages into the first sliding groove 671f in a movable manner. Through the cooperation of the first sliding portion 663f and the first sliding groove 671f, the sliding member 66f can be driven to move along the second axis C2. Preferably, the first sliding groove 671f is axisymmetric, allowing the sliding member 66f to move back and forth along the second axis C2.

The mounting seat 42f of the first stimulation unit 40f is fixedly connected to the sliding member 66f in the axial direction, and thus the first stimulation unit 40f and the swinging unit can be driven to move back and forth along the central axis C0. In this embodiment, a protrusion 661f extends outward from the sliding member 66f. The protrusion 661f may be configured as a rod, a block, and etc. The mounting seat 42f is provided with a plug-in hole 421f (referring to FIGS. 15-16), and the protrusion 661f is inserted into the plug-in hole 421f to drive the mounting seat 42f to move. In other embodiments, the protrusion 661f may be set on the mounting seat 42f, and correspondingly, the plug-in hole 421f may be defined in the sliding member 66f.

In other embodiments, the sliding member 66f and the mounting seat 42f may be connected together directly via bonding, welding, or other means; or, the sliding member 66f may be connected to the mounting seat 42f through other connecting components.

In the illustrated embodiment, the rotary member 67f is directly connected to the second output shaft 621f of the second driving member 62f. The second output shaft 621f preferably has a non-circular cross-section, and the rotating member 67f forms a corresponding hole in which the second output shaft 621f is inserted. The second output shaft 621f and the rotating member 67f are fixed in the circumferential direction through shape-fitting, so as to rotate synchronously. In other embodiments, the rotary member 67f and the second output shaft 621f may be fixed in the circumferential direction for synchronous rotation through other means, which is not limited in this application.

The second stimulation unit 60f may further include a guide member 68f, which is fixedly set in the massage device 100f, such as fixedly connected to a housing of the second driving member 62f. The guide member 68f is provided with a second sliding groove 681f, which extends linearly along the second axis C2. Correspondingly, a second sliding portion 665f is provided on the sliding member 66f and engaged into the second sliding groove 681f of the guide member 68f in a movable manner. Through the cooperation of the second sliding portion 665f and the second sliding groove 681f, not only can the sliding member 66f be fixed in the circumferential direction, but it can also guide the movement of the sliding member 66f in the axial direction, thereby moving more smoothly.

The first sliding portion 663f and the second sliding portion 665f may be formed separately and then assembled onto the sliding member 66f, or may be formed integrally with the sliding member 66f.

It should be understood that the second transmission unit 64f is used to convert the rotational motion of the second driving member 62f into linear movement of the sliding member 66f, thereby driving the first stimulation unit 40f to move along the axial direction of the chamber 22f. In other embodiments, the second transmission unit 64f may have other structures, such as a screw structure similar to the first transmission unit 46f, as long as it can drive the mounting seat 42f of the first stimulation unit 40f to move in the axial direction.

For the massage device 100f of this embodiment, the first driving member 44f drives the swinging bars 20f to move towards or away from each other, producing a clamping effect on the part of the human body inside the chamber 22f; and, at the same time, the second driving member 62f drives the entire first stimulation unit 40f and the swinging bars 20f to slide in the axial direction, producing a pulling effect on the part of the human body inside the chamber 22f. In this way, the clamping and pulling effects are combined to form a more effective stimulation on the part of the human body inside the chamber 22f.

During operation, the penis, the arm, and etc. of the human body may be inserted into the chamber 22f among the swinging bars 20f when the swinging unit is in the open state. The swinging unit can be driven to clamp the penis, arm, and etc., and then the swinging unit, together with the first stimulation unit 40f, can be driven to move linearly in the axial direction, so that the swinging unit can pull and slide relative to the penis, arms, and etc., so that the part of the human body inside the chamber 22f can be effectively stimulated. In addition, the sliding of the swinging unit allows it to act on various positions of the massaged part, further enhancing the massaged effect.

As shown in FIG. 13 and FIG. 15, in an initial state of this massage device 100f, the first stimulation unit 40f is at the first position P1 in the axial direction and the swinging unit is in the open state. In this case, the part of the human body that needs to be massaged can be inserted into the chamber 22f and thus surrounded by the swinging bars 20.

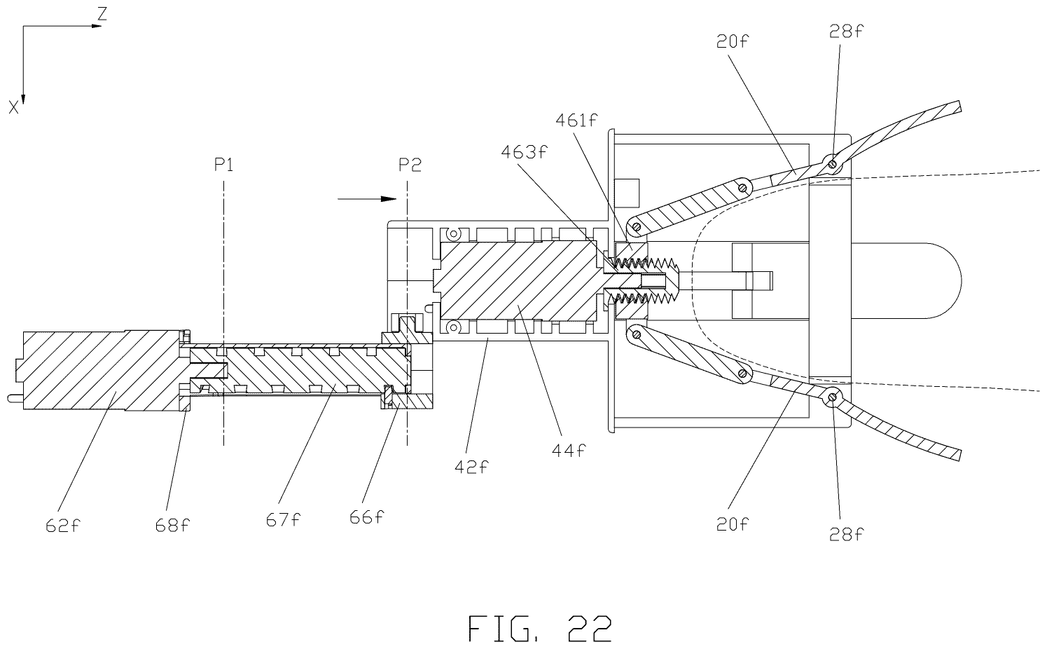

During operation of the massage device 100f, firstly the second driving member 62f starts, driving the entire first stimulation unit 40f and the swinging bars 20 to move together along the axial direction to the second position P2, as shown in FIGS. 21-22. During this process, the swinging unit is maintained in the open state. Then, the second driving member 62f pauses and the first driving member 44f starts, driving the swinging ends 26f of the swinging bars to swing towards the central axis C0 of the chamber 22f. The swinging unit thus switches to the clamping state and the swinging ends 26f clamp the part of the human body in the chamber 22f, as shown in FIGS. 23-24.

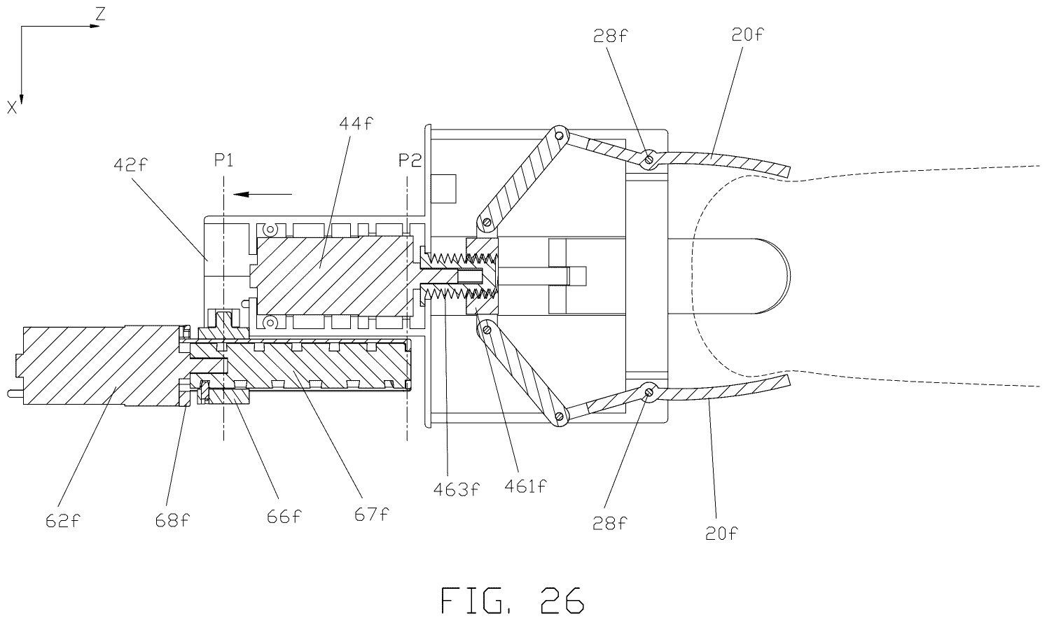

Afterwards, the first driving member 44f pauses and the second driving member 62f restarts, driving the entire first stimulation unit 40f and the swinging bars 20 to move in an opposite axial direction, returning from the second position P2 to the first position P1, as shown in FIGS. 25-26. During this process, the swinging unit is maintained in the clamping state to pull the part of the human body in the chamber 22f. During this process, the swinging ends 26f of the swinging bars 20 may slide relative to the part of the human body in the chamber 22f, further stimulating the part of the human body.

Finally, the second driving member 62f stops and the first driving member 44f restarts, driving the swinging ends 26f of the swinging bars 20 to swing away from the central axis C0 of the chamber 22f. The swinging unit thus switches to the open state and releases the part of the human body in the chamber 22f. In this case, the massage device 100f returns to its initial state, as shown in FIGS. 13 and 15. The above steps repeat continuously, making the swinging unit of the massage device 100f continuously clamp and pull the part of the human body, achieving better stimulation effect.

In the above embodiment, during the movement of the swinging unit between the two positions P1, P2, the swinging unit is always maintained in the open state or clamping state. In some embodiments, the state of the swinging unit may be changed during its movement between the two positions P1, P2.

For example, in the step of the swinging unit moving from the second position P2 to the first position P1, under the control of the controller 50f, the first driving member 44f may be activated with a rotary direction thereof being changed according to a predetermined rule, so that the swinging unit may switch between the clamping state and the open state according to the predetermined rule. In addition, the controller 50f may control the duration of the pause of the first driving member 44f, thereby controlling the duration of the swinging unit remaining in the open state or the clamping state.

For example, the swinging unit may be kept in the open state for a duration of S1 and in the clamping state for a duration of S2, where S2 may be longer than, equal to, or shorter than S1. Preferably, S2 is slightly longer than S1, so the swinging unit can be maintained in the clamping state for an appropriate amount of time, which can effectively pull the part of the human body in the chamber 22f, and avoid excessive pulling the part of the human body due to prolonged clamping state, resulting in a more comfortable user experience.

Similarly, during the step of the swinging unit moving from the first position P1 to the second position P2, under the control of the controller 50f, the first driving member 44f may be activated with a rotary direction thereof being changed according to a predetermined rule, so that the swinging unit may switch between the clamping state and the open state according to the predetermined rule. In addition, the controller 50f may control the duration of the pause of the first driving member 44f, thereby controlling the duration of the swinging unit remaining in the open state or the clamping state.

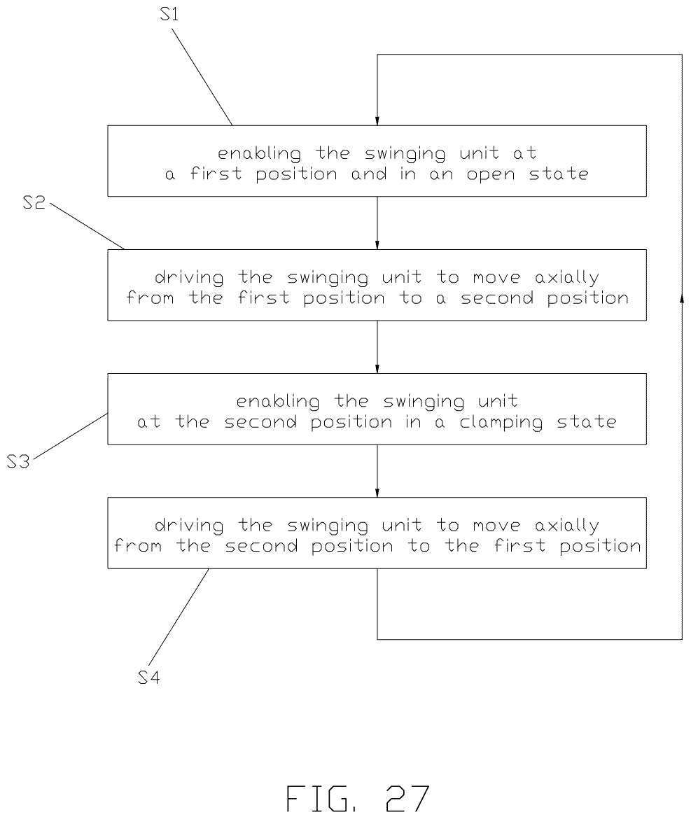

Referring to FIG. 27, the present application further provides a massage method based on the massage device 100f described above, comprising steps:
S1, enabling the swinging unit at the first position P1 and in the open state;
S2, driving the swinging unit to move along an axial direction of a chamber 22f from the first position P1 to a second position P2;
S3, driving the swinging unit at the second position P2 in a clamping state; and
S4, moving the swinging unit to move along the axial direction of the chamber 22f from the second position P2 to the first position P1.

In some embodiments, the swinging unit is always kept in the open state in step S2.

In some embodiments, the swinging unit is always kept in the clamping state in step S4, so as to pull the part of the human body accommodated in the chamber 22f and clamped by the swinging ends 26f of the swinging bars 20f of the swinging unit.

In some embodiments, the swinging unit may switch between the open state and the clamping state in step S2, such as switching from the open state to the clamping state at least once and from the clamping state to the open state once.

In some embodiments, the swinging unit may switch between the clamping state and the open state in step S4, such as switching from the clamping state to the open state as at least once and switching from the open state to the clamping state once.

During the above steps, when the swinging unit switches from the open state to the clamping state, the swinging ends 26f of the swinging bars 20f move towards the central axis C0 of the chamber 22f, making the size of the chamber 22f at a position corresponding to the swinging ends 26f decrease, so as to clamp the part of the human body accommodated in the chamber 22f; and, when the swinging unit switches from the clamping state to the open state, the swinging ends 26f move away from the central axis C0, making the size of the chamber 22f at the position corresponding to the swinging ends 26f increase, so as to release the part of the human body accommodated in the chamber 22f.

It should be understood that when the swinging ends 26f of the swinging bars 20f clamp the part of the human body accommodated in the chamber 22f and move in the axial direction, the part of the human body being clamped will be pulled and deform to a certain extent. Due to the limited deformation ability of human body, when the swinging ends 26f move a certain distance, they will slide relative to the part of the human body. For example, when the massage device 100f is used to stimulate the male penis, the swinging ends 26f may clamp the penis and slide from the root of penis to the glans penis. For another example, when the massage device 100f is used to massage human arm, the swinging ends 26f may clamp the arm and slide from the elbow to the wrist. Therefore, the stimulation effect of the massage device 100f is better.

Finally, it should be noted that: the above merely describes preferred embodiments of the present application without intention to limit the scope of the present application. Although the present application has been described in detail with reference to the foregoing embodiments, for those skilled in the art, the technical solutions described in the foregoing embodiments can still be modified, or some of the technical features can be equally replaced. Any modifications, equivalent replacements, improvements, and etc. made within the spirit and principle of the present application should be within the scope of the present application.

What is claimed is:

1. A massage device comprising:
a swinging unit comprising a plurality of swinging bars, a chamber for accommodating a male penis being defined among the swinging bars;
a first stimulation unit being connected to the swinging bars, configured for driving the swinging bars to move towards or away from a central axis of the chamber; and
a second stimulation unit connected to the first stimulation unit, configured for driving the first stimulation unit and the swinging unit to move along an axial direction of the chamber.

2. The massage device according to claim 1, wherein the first stimulation unit comprises a mounting seat, each of the swinging bars is rotatably connected to the mounting seat, and the first stimulation unit is configured for driving the swinging bars to swing towards or away from the central axis of the chamber.

3. The massage device according to claim 2, wherein one end of the swinging bar is configured as a connecting end and another end of the swinging bar is configured as a swinging end, and the swinging ends of the swinging bars extend out of the mounting seat for clamping the male penis.

4. The massage device according to claim 3, wherein a middle portion of each of the swinging bars is rotatably connected to the mounting seat through a pivot that extends perpendicular to the central axis of the chamber.

5. The massage device according to claim 3, wherein the first stimulation unit further comprises a connecting base and a first driving member configured for driving the connecting base to move along the central axis of the chamber, and the connecting ends of the swinging bars are rotatably connected to the connecting base.

6. The massage device according to claim 5, wherein the first stimulation unit further comprises a screw rod with one end thereof connected to the first driving member and another end thereof being threadedly engaged into the connecting base.

7. The massage device as claimed in claim 6, wherein the first driving member is a rotary motor, and a controller is provided inside the mounting seat for controlling a rotary direction of the rotary motor.

8. The massage device according to claim 5, wherein at least one connecting rod is hinged between each of the swinging bars and the connecting base.

9. The massage device according to claim 2, wherein the second stimulation unit comprises a sliding member and a second driving member configured for driving the sliding member to move linearly, and the mounting seat is fixed to the sliding member in the axial direction of the chamber.

10. The massage device according to claim 9, wherein one of the sliding member and the mounting seat is provided with a plug-in hole, and another one of the sliding member and the mounting seat is provided with a protrusion that is engaged into the plug-in hole.

11. The massage device according to claim 9, wherein the second stimulation unit further comprises a rotary member being rotatable about an axis which is collinear with or parallel to the central axis of the chamber under the driving of the second driving member, a spiral-shaped first sliding groove is provided on the rotary member, and a first sliding portion is provided on the sliding member and engaged into the first sliding groove in a movable manner.

12. The massage device according to claim 11, wherein the first sliding groove is axisymmetric.

13. The massage device according to claim 11, wherein the second stimulation unit further comprises a guide member being fixedly set inside the massage device, the guide member is provided with a second sliding groove that extends axially, and a second sliding portion is provided on the sliding member and engaged into the second sliding groove in a movable manner.

14. A massage method based on the massage device of claim 1, comprising:
S1, enabling the swinging unit of the massage device at a first position and in an open state;
S2, driving the swinging unit to move along the axial direction of the chamber from the first position to a second position;
S3, enabling the swinging unit at the second position in a clamping state; and
S4, driving the swinging unit to move along the axial direction of the chamber from the second position to the first position.

15. The massage method according to claim 14, wherein
in step S4, the swinging unit is always kept in the clamping state.

16. The massage method according to claim 14, wherein
in step S4, the swinging bars of the swinging unit are driven to move towards or away from the central axis of the chamber to change the state of the swinging unit.

17. The massage method according to claim 14, wherein
in step S2, the swinging unit is always kept in the open state.

18. The massage method according to claim 14, wherein
in step S2, the swinging bars of the swinging unit are driven to move towards or away from the central axis of the chamber to change the state of the swinging unit.

19. The massage method according to claim 14, wherein
in the open state, swinging ends of the swinging bars of the swinging unit are relatively away from each other, so as to release the male penis inside the chamber; and
in the clamping state, swinging ends of the swinging bars are relatively adjacent to each other, so as to clamp the mal penis inside the chamber.
